(19) United States
(12) Patent Application Publication
(10) Pub. No.: US 2020/0018506 A1
(43) Pub. Date: Jan. 16, 2020

(54) SYSTEM AND METHOD FOR DUAL OCCUPANCY DETECTION

(71) Applicant: Emerson Electric Co., St. Louis, MO (US)

(72) Inventors: Randy T. Ruiz, St. Peters, MO (US); G. Scott Vogel, Fenton, MO (US); Rishi Siravuri, Maryland Heights, MO (US)

(21) Appl. No.: 16/031,678

(22) Filed: Jul. 10, 2018

(51) Int. Cl. F24F 11/46; G05B 15/02; G05D 23/19; H04W 4/021

(52) U.S. Cl. CPC F24F 11/46; G05B 15/02; F24F 2120/10; H04W 4/021; G05B 2219/2614; G05D 23/1917

(57) ABSTRACT

A system and method of detecting occupancy of a conditioned space are provided. The method includes controlling an environmental parameter of the conditioned space to a first selectable value using a first output signal of a process controller. The process controller configured to receive an indication of the environmental parameter of the conditioned space. The method also includes receiving a first indication of occupancy of the conditioned space using a passive occupancy sensor, receiving a second indication of occupancy of the conditioned space using an active occupancy sensor, and determining an occupancy state of the conditioned space based on a correlation between the first indication of occupancy and the second indication of occupancy. The method further includes controlling the environmental parameter of the conditioned space to a second selectable value based on the determined occupancy state.

### BACKGROUND

This description relates to process control systems, and, more particularly, to occupancy detection used with process controllers.

At least some known heating, ventilating, and air conditioning (HVAC) systems use remote sensors to determine if a room is occupied or not. Most remote sensors use passive infrared (PIR) elements to determine occupancy. PIR sensors depend on movement to detect occupancy. If a person sits in a room, watching TV for example, the PIR sensors can become blind to the person due to lack of movement.

Sensors based on other technologies have also been attempted to detect occupancy, for example, ultrasonic sensors and microwave sensors, however, these sensors also exhibit shortcomings that make their use in occupancy detection subject to false positive indications as well as false negative indications.

### BRIEF DESCRIPTION

In one embodiment, a method of detecting occupancy of a conditioned space includes controlling an environmental parameter of the conditioned space to a first selectable value using a first output signal of a process controller. The process controller is configured to receive an indication of the environmental parameter of the conditioned space. The method also includes receiving a first indication of occupancy of the conditioned space using a passive occupancy sensor, receiving a second indication of occupancy of the conditioned space using an active occupancy sensor, and determining an occupancy state of the conditioned space based on a correlation between the first indication of occupancy and the second indication of occupancy. The method further includes controlling the environmental parameter of the conditioned space to a second selectable value based on the determined occupancy state.

In another embodiment, a temperature control system includes a thermostat device including at least one temperature sensor for use in sensing an air temperature of a conditioned space and an occupancy sensor system. The occupancy sensor system including at least one occupancy sensor configured to detect a proximal user presence in the conditioned space, at least one Received Signal Strength Indication (RSSI) sensor including a radio transceiver and configured to determine a strength of a radio signal, and a processing system communicatively coupled to the occupancy sensor, the at least one temperature sensor, and the RSSI sensor. The processing system is configured to receive a user-selected temperature value, receive a sensed conditioned space air temperature from the at least one temperature sensor, transmit a control signal to an HVAC system based at least in part on a comparison of the user-selected temperature value and the sensed ambient air temperature. The processing system is also configured to detect a non-occupancy of the conditioned space using the occupancy sensor, verify the detected non-occupancy using the RSSI sensor, and modify the control signal based on the verified non-occupancy of the conditioned space.

In yet another embodiment, an occupancy sensing system includes a plurality of passive occupancy sensors, a plurality of active occupancy sensors, a temperature controller including a processor communicatively coupled to a non-transitory memory device, the plurality of passive occupancy sensors, and the plurality of active occupancy sensors. The memory device includes instructions, which when executed by the processor cause the processor to control an environmental parameter of a conditioned space to a first selectable value using a first output signal of the temperature controller. The process controller is configured to receive an indication of the environmental parameter of the conditioned space, receive a first indication of occupancy of the conditioned space using a passive occupancy sensor, receive a second indication of occupancy of the conditioned space using an active occupancy sensor, determine an occupancy state of the conditioned space based on a correlation between the first indication of occupancy and the second indication of occupancy, and control the environmental parameter of the conditioned space to a second selectable value based on the determined occupancy state.

### BRIEF DESCRIPTION OF THE DRAWINGS

FIGS. 1-3 show example embodiments of the method and apparatus described herein.

FIG. 1 is a schematic block view of a temperature control system in accordance with an example embodiment of the present disclosure.

FIG. 2 is another schematic block view of the temperature control system shown in FIG. 1.

FIG. 3 is a flowchart of an example method of detecting occupancy of a conditioned space.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to analytical and methodical embodiments of detecting occupancy in conditioned spaces in industrial, commercial, and residential applications.

Embodiments of a smart temperature controller or thermostat are described herein. The purpose of the smart temperature controller is to reduce energy consumption by detecting a presence of an occupant in a conditioned space where the energy is being consumed. When occupancy is detected the smart temperature controller can control the environmental conditioning equipment for the conditioned space to provide comfort to the occupant. When the conditioned space is detected as being vacant, the smart temperature controller can control the environmental conditioning equipment for the conditioned space to reduce energy consumption related to the environment in the conditioned space.

Smart appliances are those that are aware of a state of their associated equipment and that can act accordingly. For at least some known appliances, a central element of such a state is the presence of human occupants and their number. For smart homes, office buildings, and other conditioned spaces, such occupancy information can be used for saving energy and for safety purposes. While acquiring occupancy information is important for such appliances, using sensing techniques that are highly intrusive, such as cameras, is often not acceptable for the building occupants. Some known occupancy detection methods use only a passive infrared (PIR) sensor to attempt to determine the occupancy of a conditioned space. To alleviate the problems associated with using only PIR to detect occupancy mentioned above, passive electromagnetic signal detection is also used. The ubiquitousness of personal mobile devices, such as, but not limited to cell phones and tablets permits a non-intrusive correlatable occupancy detection channel that, in concert with PIR, improves the accuracy of the occupancy determination. For example, for a mobile phone, the Received Signal Strength Indication (RSSI) of Bluetooth Low Energy (BLE) nodes deployed around workspaces to localize the phone in a room. The sensor fusion of a plurality of sensing modalities permits greater occupancy detection accuracy.

Embodiments of the present disclosure combines a Bluetooth® radio with the PIR in each remote sensors, such that when the PIR detects movement, the Bluetooth® radio in the sensor transmits a beacon to an conditioned space where occupancy is to be determined. Any user mobile device receives the beacon signal and transmits a response, which is received by the Bluetooth® receiver in the remote sensor, which has an associated RSSI with it. The remote sensor periodically transmits the Bluetooth® or other beacon, when the PIR sensor becomes blind due to inactivity in the room, to determine if the room is still occupied by comparing the instant RSSI, with a previous RSSI value. The RSSI values being approximately equal is an indication that the room is still occupied, if less, is an indication it is no longer occupied.

This information is transmitted to a central thermostat, which uses the information to determine if the conditioned space being monitored is occupied or not. If one of the remote sensors indicates occupancy, then the conditioned space is occupied. The status of occupied versus unoccupied is used to determine the operational setpoint of the system.

The following description refers to the accompanying drawings, in which, in the absence of a contrary representation, the same numbers in different drawings represent similar elements.

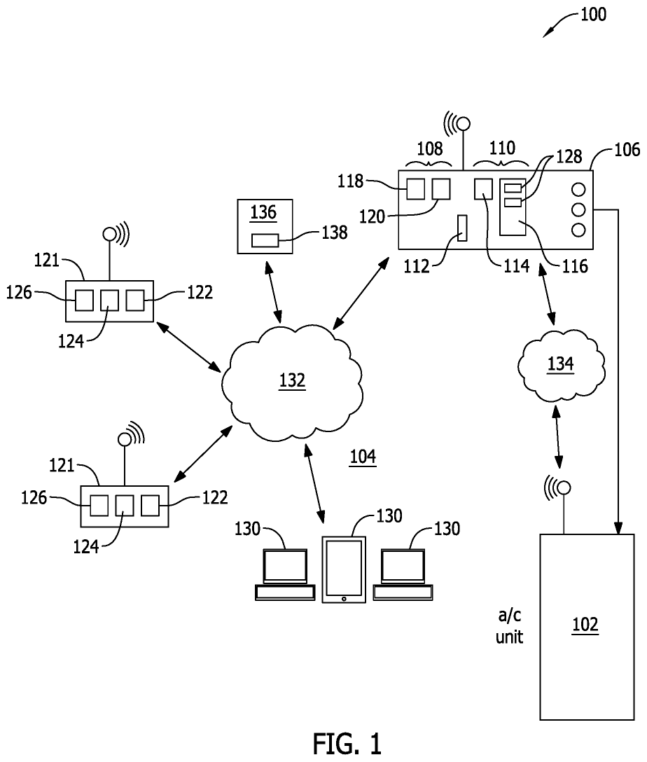

FIG. 1 is a schematic block view of a temperature control system 100. In the example embodiment, temperature control system 100 is configured to control an operation of an air conditioning unit 102, which is configured to maintain selectable ambient conditions within a conditioned space 104. Temperature control system 100 includes a thermostat device 106 communicatively coupled to air conditioning unit 102, an occupancy sensor system 108, and a processing system 110 communicatively coupled to occupancy sensor system 108 and at least one temperature sensor 112. Processing system 110 includes at least one processor 114 communicatively coupled to at least one memory device 116. In one embodiment, thermostat device 106 houses at least one temperature sensor 112, at least a portion of occupancy sensor system 108, and at least a portion of processing system 110. In the example embodiment, occupancy sensor system 108 includes a passive occupancy sensor 118 and an active occupancy sensor 120. Passive occupancy sensor 118 may be embodied in, for example, a passive infrared (PIR) sensor and active occupancy sensor 120 may be embodied in, for example, a radio transceiver capable of receiving and transmitting electromagnetic radiation, an ultrasonic sensor, a microwave sensor, an audio detector, a camera-based sensor and combinations thereof. Passive occupancy sensor 118 is configured to detect a proximal user presence in the conditioned space. Active occupancy sensor 120 includes a received signal strength section configured to determine a strength of a radio signal received by active occupancy sensor 120.

In some embodiments, separate remote auxiliary devices 121 may contain at least one remote temperature sensor 122 for use in sensing an air temperature of conditioned space 104. Remote auxiliary devices 121 may also include a remote passive occupancy sensor 124 configured to detect a proximal user presence in conditioned space 104, and a remote active occupancy sensor 126 configured to determine a strength of a radio signal received by remote active occupancy sensor 126.

At least one memory device 116 includes specific memory locations 128 used to hold program data and to store working data, in for example, a database architecture. The database architecture is defined by a set of specifications, rules, and processes that direct how data is stored in a database and how data is accessed by components of a system. The database architecture includes data types, relationships, and naming conventions. The database architecture describes the organization of all database objects and how they work together. It affects integrity, reliability, scalability, and performance. The database architecture involves anything that defines the nature of the data, the structure of the data, or how the data flows. Program instructions or computer-readable code for operating thermostat device 106 may be embodied or provided within one or more computer-readable media, thereby making a computer program product.

One or more user access devices 130 may be communicatively coupled to any of the components of temperature control system 100 either directly or through network 132 and/or network 134. User access devices 130 may include any devices capable of receiving information from the network 132. The user access devices 130 could include specialized computing components and/or embedded systems optimized with specific components for performing specific tasks. Examples of user access devices 130 include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. User access devices 130 can also include various other elements, such as processes running on various machines.

The network 132 may include any element or system that facilitates communications among and between various network nodes, such as devices 130, 121, 106 and 102. Network 132 may include one or more telecommunications networks, such as computer networks, telephone or other communications networks, the Internet, etc. Network 132 may include a shared, public, or private data network encompassing a wide area (e.g., WAN) or local area (e.g., LAN). In some implementations, network 132 may facilitate data exchange by way of packet switching using the Internet Protocol (IP). Network 132 may facilitate wired and/or wireless connectivity and communication.

Temperature control system 100 may further include a website 136 including one or more resources 138 (e.g., text, images, multimedia content, and programming elements, such as scripts) associated with a domain name and hosted by one or more servers. Resources 138 can be relatively static (e.g., as in a publisher's webpage) or dynamically generated in response to user query (e.g., as in a search engine's result page).

For purposes of explanation only, certain aspects of this disclosure are described with reference to the discrete elements illustrated in FIG. 1. The number, identity and arrangement of elements in temperature control system 100 are not limited to what is shown. For example, temperature control system 100 can include any number of geographically-dispersed thermostat devices 106, remote auxiliary devices 121, and/or user access devices 130, which may be discrete, integrated modules or distributed systems.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

During operation, processing system 110 is configured to receive a user-selected temperature value. In some embodiments, user-selected temperature value is a user-defined setpoint to which the operation of air conditioning unit 102 is controlled. Processing system 110 also receives a sensed conditioned space air temperature from at least one temperature sensor 112. In some embodiments, user-selected temperature value is a user-defined setpoint to which the operation of air conditioning unit 102 is controlled. Processing system 110 evaluates the sensed conditioned space air temperature with respect to the user-selected temperature value to generate an HVAC system control signal, which is transmitted to air conditioning unit 102 associated with thermostat device 106. Temperature control system 100 monitors conditioned space 104 for non-occupancy times during which control of air conditioning unit 102 can be modified to reduce energy usage. Temperature control system 100 detects a non-occupancy state of conditioned space 104 using remote passive occupancy sensor 124, which may be embodied in a PIR sensor. In some situations, such as, when an occupant remains still in conditioned space 104, remote passive occupancy sensor 124 may generate a false non-occupancy signal. To alleviate such a possibly, temperature control system 100 verifies the detected non-occupancy using active occupancy sensor 120, which may be embodied in an RSSI sensor, for example, a radio transceiver capable of receiving and transmitting electromagnetic radiation, not necessarily in the infrared range. Temperature control system 100 is further configured to modify the control signal based on the verified non-occupancy of conditioned space 104. Smart buildings and buildings retro-fitted with smart components can benefit greatly from timely and accurate person location indications and hence the data fusion of fixed and wireless mobile computing devices is important to realize those benefits.

In some embodiments, passive occupancy sensor 118, remote passive occupancy sensor 124, active occupancy sensor 120, and/or remote active occupancy sensor 126 may include a time delay or timer feature that indicates a length of time since a previous change of state, for example, a transition from occupancy being detected to occupancy not being detected, and vice versa. For example, passive occupancy sensor 118, remote passive occupancy sensor 124, active occupancy sensor 120, and/or remote active occupancy sensor 126 may indicate a length of time since occupancy was last detected.

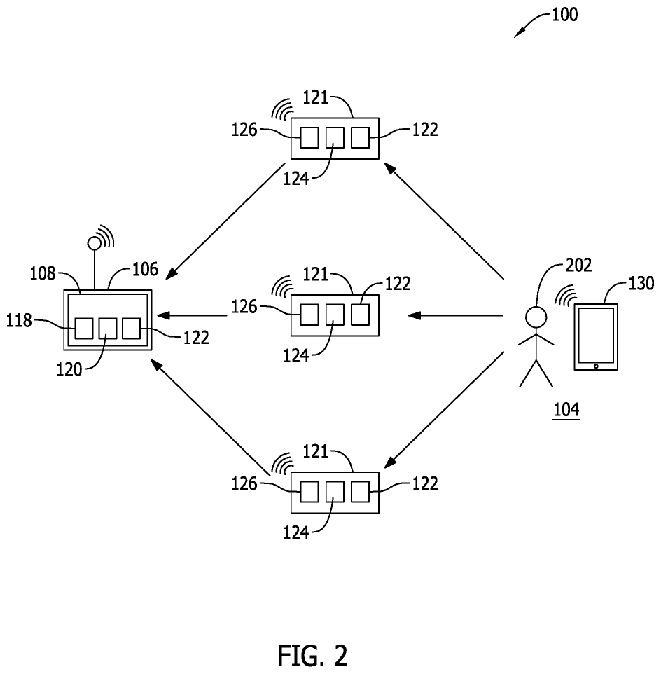

FIG. 2 is another schematic block view of temperature control system 100 (shown in FIG. 1). In the example embodiment, temperature control system 100 includes at least one thermostat device 106, at least one remote auxiliary device 121, and a user 202 or occupant having user access device 130. User 202 typically maintains user access device 130 in relatively close proximity to user's body, for example, within an arm's length away for convenient use of user access device 130. This observation is part of the basis for using active occupancy sensor 120 and remote active occupancy sensor 126 in conjunction with passive occupancy sensor 118 and remote passive occupancy sensor 124. With normal activity of user 202 within conditioned space 104, passive occupancy sensor 118 and remote passive occupancy sensor 124 detect user 202 while user 202 remains within a field of view (FOV) of passive occupancy sensor 118 and remote passive occupancy sensor 124. A means of detection of user 202 by passive occupancy sensor 118 and remote passive occupancy sensor 124 may include passive infrared, delta image, passive sonic, or combinations thereof. Because some environmental conditions within conditioned space 104 may generate false position occupancy signals or false negative signals, a data fused approached is used with active occupancy sensor 120 and remote active occupancy sensor 126 to mitigate false signals. A false positive signal may indicate a presence of user 202 when, if fact, user 202 is not occupying conditioned space 104. False positive signals may arise from heat signatures due to sunlight, heating registers, and reflections of infrared energy. False negative signals may arise from user 202 maintaining an inactive state for a prolonged period of time, or user 202 being outside the FOV of passive occupancy sensor 118 and remote passive occupancy sensor 124.

Occupancy data from passive occupancy sensor 118 and remote passive occupancy sensor 124, of which there may be more than one, is periodically or continuously determined and transmitted to thermostat device 106. Thermostat device 106 acts as a hub for collecting occupancy data and environmental parameter data from as many remote passive occupancy sensors 124 as exist in temperature control system 100. Although illustrated with only two remote auxiliary devices 121 in FIG. 1 and three remote auxiliary devices 121 in FIG. 2, temperature control system 100 can have any number of remote auxiliary devices 121.

In one embodiment, occupancy or non-occupancy of conditioned space 104 is determined using passive occupancy sensor 118 and remote passive occupancy sensor 124. Thermostat device 106 generates a control signal for air conditioning unit 102 based on the determination of whether conditioned space 104 is occupied or not. In a cooling mode of thermostat device 106, the control signal may be embodied in a higher temperature setpoint when conditioned space 104 is determined to be unoccupied. In a heating mode of thermostat device 106, the control signal may be embodied in a lower temperature setpoint when conditioned space 104 is determined to be unoccupied.

A false positive occupancy signal or a false negative occupancy signal causes the thermostat device 106 to generate an incorrect temperature setpoint relative to the comfort level and energy efficiency goals for conditioned space 104. To mitigate the effects of a false positive occupancy signal or a false negative occupancy signal, active occupancy sensor 120 and remote active occupancy sensor 126 are used to verify the occupancy or non-occupancy of conditioned space 104. In one embodiment, active occupancy sensor 120 and remote active occupancy sensor 126 transmit an interrogation or handshaking signal that will be received by user access device 130, which prompts user access device 130 to transmit a response signal. Active occupancy sensor 120 and remote active occupancy sensor 126 receive the response signal and each measures the signal strength of the response signal. Differences between the signal strengths received by each of active occupancy sensor 120 and remote active occupancy sensors 126 is used to determine a presence of user access device 130 and hence user 202 based on the assumption that user 202 will maintain user access device 130 nearby. The relative signal strengths of the received response signals can also be used to determine a location of user access device 130 and user 202 within conditioned space 104. In other embodiments, user access device 130 transmits an interrogation signal, which is received by active occupancy sensor 120 and remote active occupancy sensor 126 to determine the occupancy or non-occupancy of conditioned space 104.

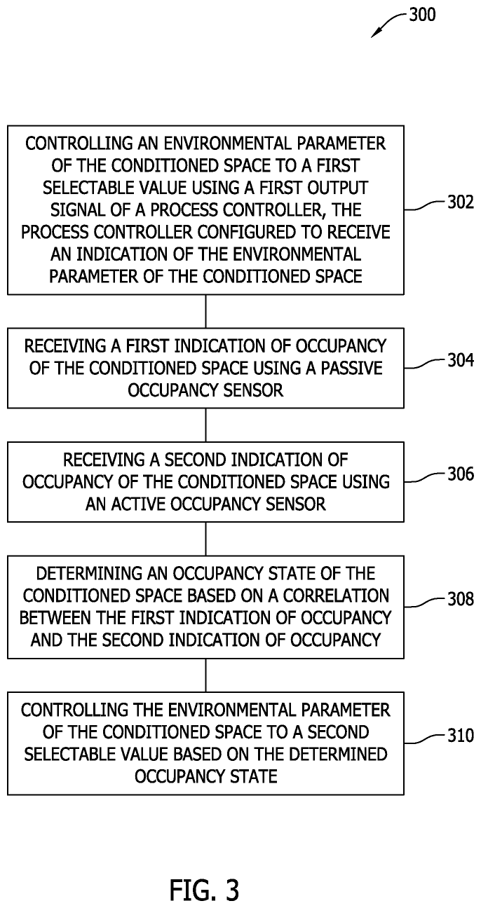

FIG. 3 is a flowchart of an example method 300 of detecting occupancy of a conditioned space. In the example embodiment, method 300 includes controlling 302 an environmental parameter of conditioned space 104 to a first selectable value using a first output signal of a process controller, such as, but not limited to thermostat device 106. Thermostat device 106 is configured to receive an indication of the environmental parameter of conditioned space 104. Typical environmental parameters that may be used in the various embodiments described herein include air temperature and humidity, such as, relative humidity of conditioned space 104. Typical residential and commercial thermostat devices only have the capability of measuring temperature, however, higher-end systems or systems that need to specifically address humidity and water vapor may also have a humidity sensor.

Method 300 also includes receiving 304 a first indication of occupancy of the conditioned space using for example, passive occupancy sensor 118 and remote passive occupancy sensor 124, which may be embodied in an infrared receiver. Passive occupancy sensor 118 and remote passive occupancy sensor 124 have respective fields of view (FOV) that defines the portion of conditioned space 104 that passive occupancy sensor 118 and remote passive occupancy sensor 124 can receive infrared signals from. Because of limitations on the FOV or other conditions, such as, prolonged inactivity of user 202, passive occupancy sensor 118 and/or remote passive occupancy sensor 124 may not be able to generate an accurate occupancy signal. Method 300 further includes receiving 306 a second indication of occupancy of conditioned space 104 using active occupancy sensor 120 and/or remote active occupancy sensor 126. Method 300 also includes determining 308 an occupancy state of conditioned space 104 based on a correlation between the first indication of occupancy and the second indication of occupancy. In some cases where passive occupancy sensor 118 and/or remote passive occupancy sensor 124 cannot determine the occupancy of conditioned space 104, active occupancy sensor 120 and/or remote active occupancy sensor 126 will facilitate determining the occupancy state of conditioned space 104 by fusing the data from passive occupancy sensor 118, remote passive occupancy sensor 124, active occupancy sensor 120, remote active occupancy sensor 126, and combinations thereof. Method 300 includes controlling 310 the environmental parameter of conditioned space 104 to a second selectable value based on the determined occupancy state. Passive occupancy sensor 118, remote passive occupancy sensor 124, active occupancy sensor 120, remote active occupancy sensor 126 operating in conjunction, periodically or continuously update the determined occupancy state of conditioned space 104 and use that determination to modify the operation of air conditioning unit 102 by transmitting a control signal or message from thermostat device 106 to air conditioning unit 102.

The above-described embodiments of the disclosure may be implemented at least partially using computer programming or engineering techniques including computer software, firmware, hardware or any combination or subset thereof, the technical effect of the methods and systems may be achieved by verifying or backing-up the operation of a first type of occupancy sensor associated with a conditioned space with a second type of occupancy sensor. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

The foregoing detailed description illustrates embodiments of the disclosure by way of example and not by way of limitation. It is contemplated that the disclosure has general application to detection of motion and occupancy in monitored spaces. It is further contemplated that the methods and systems described herein may be incorporated into existing temperature control or other building automation systems, in addition to being maintained as a separate stand-alone application.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 212 and by devices that include, without limitation, mobile devices, clusters, personal computers, workstations, clients, and servers, including RAM memory, ROM memory, EPROM memory, EEPROM memory, and non-volatile RAM (NVRAM) memory. The above memory types are examples only, and are thus not limiting as to the types of memory usable for storage of a computer program.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of detecting occupancy of a conditioned space, said method comprising:
controlling an environmental parameter of the conditioned space to a first selectable value using a first output signal of a process controller, the process controller configured to receive an indication of the environmental parameter of the conditioned space;
receiving a first indication of occupancy of the conditioned space using a passive occupancy sensor;
receiving a second indication of occupancy of the conditioned space using an active occupancy sensor;
determining an occupancy state of the conditioned space based on a correlation between the first indication of occupancy and the second indication of occupancy; and
controlling the environmental parameter of the conditioned space to a second selectable value based on the determined occupancy state.

2. The method of claim 1, wherein controlling an environmental parameter of the conditioned space comprises:
receiving an indication of the environmental parameter associated with the conditioned space; and
generating a control signal based on a deviation of the received indication from a selectable threshold range.

3. The method of claim 1, wherein determining an occupancy state of the conditioned space based on a correlation between the first indication of occupancy and the second indication of occupancy comprises determining a first indication of occupancy of the conditioned space using a passive occupancy sensor simultaneously with determining a second indication of occupancy using an active occupancy sensor.

4. The method of claim 1, wherein determining an occupancy state of the conditioned space based on a correlation between the first indication of occupancy and the second indication of occupancy comprises determining an occupancy state of the conditioned space using the second indication of occupancy of the conditioned space after the first indication of occupancy of the conditioned space is lost.

5. The method of claim 1, wherein managing an environmental parameter of the conditioned space comprises managing at least one of a temperature and a humidity of the conditioned space.

6. A temperature control system comprising:
a thermostat device comprising:
at least one temperature sensor for use in sensing an air temperature of a conditioned space;
an occupancy sensor system comprising:
at least one occupancy sensor configured to detect a proximal user presence in the conditioned space;
at least one Received Signal Strength Indication (RSSI) sensor comprising a radio transceiver and configured to determine a strength of a radio signal; and
a processing system communicatively coupled to the occupancy sensor, the at least one temperature sensor, and the RSSI sensor, the processing system configured to:
receive a user-selected temperature value;
receive a sensed conditioned space air temperature from the at least one temperature sensor;
transmit a control signal to an HVAC system based at least in part on a comparison of the user-selected temperature value and the sensed ambient air temperature;
detect a non-occupancy of the conditioned space using the occupancy sensor;
verify the detected non-occupancy using the RSSI sensor; and
modify the control signal based on the verified non-occupancy of the conditioned space.

7. The temperature control system of claim 6, wherein the occupancy sensor comprises a passive infrared (PIR) sensor.

8. The temperature control system of claim 6, wherein the thermostat device further comprises at least one remote occupancy sensor system communicatively coupled to the thermostat device, the at least one remote occupancy sensor system comprising at least one passive infrared (PIR) sensor configured to sense infrared radiation to detect a proximal user presence in the conditioned space and at least one RSSI sensor comprising a radio transceiver and configured to determine a strength of a radio signal.

9. The temperature control system of claim 6, further comprising a plurality of remote occupancy sensors, the processing system configured to receive RSSI signals from the plurality of remote occupancy sensors and determine an approximate location within the conditioned space of a user access device of an occupant.

10. The temperature control system of claim 9, wherein the processing system is further configured to determine a location of an occupant by triangulation of the received RSSI signals.

11. The temperature control system of claim 6, wherein said RSSI sensor is configured to periodically transmit an interrogation signal to the conditioned space and receive an interrogation response from any occupancy sensor system that receives the interrogation signal.

12. The temperature control system of claim 6, wherein the processing system is configured to detect a non-occupancy of the conditioned space based on an expiration of a predetermined time period since a detected movement in the conditioned space.

13. The temperature control system of claim 6, wherein the processing system is configured to verify the detected non-occupancy of the conditioned space based on an absence of a previously detected RSSI signal within the conditioned space.

14. The temperature control system of claim 6, wherein the processing system is further configured to determine a number of occupants of the conditioned space.

15. The temperature control system of claim 6, wherein the processing system is further configured to modify the control signal a scheduled amount corresponding to lowering the user-selected temperature value when the thermostat device is in a heat mode of operation and corresponding to raising the user-selected temperature value when the thermostat device is in a cooling mode of operation.

16. The temperature control system of claim 6, wherein the received user-selected temperature value is modified by a geo-fencing command or an automated demand response (ADR) command.

17. An occupancy sensing system comprising:
a plurality of passive occupancy sensors;
a plurality of active occupancy sensors;
a temperature controller comprising a processor communicatively coupled to a non-transitory memory device, the plurality of passive occupancy sensors, and the plurality of active occupancy sensors, said memory device comprising instructions, which when executed by the processor cause the processor to:
control an environmental parameter of a conditioned space to a first selectable value using a first output signal of the temperature controller, the process controller configured to receive an indication of the environmental parameter of the conditioned space;
receive a first indication of occupancy of the conditioned space using a passive occupancy sensor;
receive a second indication of occupancy of the conditioned space using an active occupancy sensor;
determine an occupancy state of the conditioned space based on a correlation between the first indication of occupancy and the second indication of occupancy; and
control the environmental parameter of the conditioned space to a second selectable value based on the determined occupancy state.

18. The system of claim 17, wherein at least one passive occupancy sensor of the plurality of passive occupancy sensors and at least one active occupancy sensor of the plurality of active occupancy sensors is mounted within the temperature controller.

19. The system of claim 17, wherein at least one active occupancy sensor of the plurality of active occupancy sensors comprises a radio transceiver, an ultrasonic sensor, a microwave sensor, an audio detector, a camera-based sensor and combinations thereof.

20. The system of claim 17, wherein the environmental parameter of the conditioned space comprises at least one of temperature and humidity.
